(19) United States
(12) Patent Application Publication
(10) Pub. No.: US 2020/0123843 A1
(43) Pub. Date: Apr. 23, 2020

(54) LOUVER

(71) Applicant: Vincent SOE, Tangersang (ID)

(72) Inventor: Vincent SOE, Tangersang (ID)

(21) Appl. No.: 16/658,466

(22) Filed: Oct. 21, 2019

(30) Foreign Application Priority Data
Oct. 19, 2018 (GB) 1817063.9

(51) Int. Cl. E06B 7/086

(52) U.S. Cl. CPC E06B 7/086

(57) ABSTRACT

A louver, the louver comprising an elongate body having opposed ends, the body having an outer surface, a slot extending between the opposed ends; and a wrapping disposed about the outer surface of the body, wherein at least part of the wrapping is retained in the slot. The louver may further comprise a retaining member disposed in the slot. The invention also provides a window, door, shutter or blind comprising a louver according to the present invention, and a method of wrapping a louver.

### CROSS-REFERENCE TO RELATED APPLICATION

The present application claims the benefit under 35 USC § 119 of the filing date of UK Application 1817063.9 filed 19 Oct. 2018. The entire disclosure of this prior application is incorporated herein by this reference.

### TECHNICAL FIELD

This invention is directed to a louver, and in particular, to a wrapped louver, a window, door, shutter or blind comprising a wrapped louver, and to a method of wrapping a louver.

### BACKGROUND

Windows, doors, shutters or blinds may comprise one or more louvers. A louver may be defined as one or more angled slats that are positioned horizontally (or, in certain circumstances, vertically) within a window, door, shutter or blind frame. The slats are designed principally to permit the influx of light and/or air, but also to prevent the ingress of rain or direct sunlight. Louvers may also be found in ventilation shafts, and windows comprising louvers may or may not also comprise glazing.

The louvers can be in a fixed position integrated within window, door, shutter or blind frames, or in some cases the angle of the louver can be adjustable. Louvers with adjustable slats may be installed within a movable and adjustable mechanism which positions all slats into any parallel position with respect to each other. Windows having such a mechanism may be referred to as jalousies or plantation windows.

In some cases, louvers can be disposed within the sealed unit of a double glazed window.

Louvers can be made of any material, such as wood, fibreboard, glass (opaque or colourless), or metal, such as aluminium. In some situations, the louver may be painted, but it is also known to wrap individual louvers with a material such as a plastic (including polyvinylchloride, polyethylene and polypropylene), wood veneer, paper or a fabric. The material is wrapped around the louver, and one free end will overlap the other, and be secured in placed, such as with an adhesive. The overlap of the two free ends is disadvantageous, because it may be aesthetically displeasing, be liable to retain dust, or be liable to separate causing the wrapping to become at least partially removed from the louver.

### SUMMARY

This invention addresses the problems caused with current wrapped louvers. According to a first aspect of the present invention, there is provided a louver, the louver comprising an elongate body having opposed ends, the body having an outer surface; a slot extending between the opposed ends; and a wrapping disposed about the outer surface of the body, wherein at least part of the wrapping is retained in the slot.

According to a second aspect of the present invention there is provided a window, door, shutter or blind comprising at least one louver, the louver comprising an elongate body having opposed ends, the body having an outer surface; a slot extending between the opposed ends; and a wrapping disposed about the outer surface of the body, wherein at least part of the wrapping is retained in the slot.

According to a third aspect of the present invention there is provided a method of making a louver comprising the following steps: a) providing an elongate body having opposed ends, the body having an outer surface; and a slot extending between the opposed ends; and b) disposing a wrapping about the outer surface of the louver, and inserting at least part of the wrapping into the slot to retain it.

Providing a body with a slot enables a portion of the wrapping to be retained within that slot. The slot provides a recess into the body into which at least a part of the wrapping can be inserted and retained.

The slot may extend the entire length of the body between the opposed ends, or for only a portion of that length. The slot may comprise one or more slot sections separated by sections in which no slot exists. It is preferred that the slot is substantially linear and extends parallel with a longitudinal axis of the louver.

The slot may take any shape into which the wrapping can be inserted. The slot may have a generally rectangular, U-shaped, or horseshoe-shaped profile. The profile of the slot may extend into the body from an opening and the height may be substantially constant at the height of the opening, for example a rectangular or square profile. The profile may narrow as it extends into the body, for example a U shape or V shaped profile. The profile may include a portion having a height greater than that of the opening, for example a C shape or horseshoe-shaped profile.

The slot may be dimensioned so as to interact with, or grip, the wrapping sufficiently so as to retain the wrapping in place. To facilitate the retention of the wrapping, the outermost edges of the slot may be resiliently biased towards a closed position, so as to grip the wrapping inserted therein.

Alternatively, the louver may further comprise at least one retaining member disposed within, or at least partially within, the slot to retain, or clamp, the wrapping between the retaining member and an inner surface of the slot. The retaining member may take any suitable form and be made from any suitable material such that it can be inserted into the slot and retained therein while retaining the wrapping. The retaining member may extend along any portion of the length of the slot, and may extend along the entire length of the slot. Two or more retaining members may be provided within the slot to retain the wrapping. The two or retaining members may be spaced out along the length of the slot. The spacing may be substantially even.

The retaining member may be dimensioned so that it can be arranged substantially flush with, or aligned with, the outer edges of the slot, so the slot will not be readily visible. The retaining member may be located fully within the slot such that a portion of the slot remains still visible, or the retaining member may extend out of the slot and engage a part of the external surface of the louver. The retaining member may have a substantially square or rectangular profile. The profile of the retaining member may be shaped to have a tapered portion such that the depth of the retaining member increases from a first depth, possibly from a depth less than a height of an opening of the slot, to a second depth, possibly a depth which causes the retaining member to be retained in the slot by friction, or by a slight deformation of an inner surface of the slot and/or of the retaining member when retaining the wrapping. Such an arrangement may facilitate insertion of the retaining member into the slot as the retainer can be inserted tapered portion first. Such a retainer may have an oval shape, circular shape, or a wedge shape.

The retaining member may be made from wood, plastic, glass or metal, or combinations thereof. The retaining member could be made partially from metal, and have a plastic cap portion that is external to or flush with the outer edges of the slot. A metal retaining member could act as a weight or counterbalance on louvers used in a moveable system such as a jalousie window. The retaining member could be the same colour as the louver, or wrapping, for aesthetic reasons, or could alternatively be decorated.

The louver comprises an elongate body which may be of any suitable shape. The louver may have a cross section that is substantially symmetrical about a horizontal and vertical axis and comprise opposed top and bottom faces and opposed side faces. The opposed top and bottom faces may be parallel, or may be slightly curved, giving the cross section of the louver body an elliptical appearance. The opposed top and bottom faces may each have a different profile, with one curved and the other substantially flat. The opposed side faces may be substantially straight or be rounded. The opposed side faces may be of different lengths, affording the louver a generally wedge-shaped cross section. Alternatively, the elongate body may have a cross section comprising two offset rectangles, wherein the elongate body comprises opposed top and bottom faces with offset portions and opposed side faces having offset portions.

The slot may be disposed anywhere on the louver body, but for aesthetic reasons it may be preferred that the slot is disposed on one of the side faces. When the louver is in use in a window, door, shutter or blind, it may be preferred that the slot is disposed on an external-facing side face of the louver body.

The louver may be made from any suitable material that fulfils the desired characteristics. These include cost, availability, weight and ease of manufacture. The louver may be made from wood, fibreboard, plastic (such as uPVC), glass or metal, or a combination thereof.

The wrapping may be generally rectangular and comprise first opposed edges aligned with the opposed ends of the louver, and second opposed edges. The first opposed edges may extend partially along the length of the body of the louver, but preferably the wrapping will extend the full length of the body so as to cover the louver entirely. Whilst any part of the wrapping may be retained within the slot to secure the wrapping to the louver, so as to prevent the problem of the free second opposed edges of the wrapping detaching, it is preferred that at least one, and preferably both, of the second opposed edges are retained within the slot.

The wrapping may be made from any suitable material. Selection of the wrapping material may be based on a number of criteria. For example, criteria for the selection of the wrapping material may include availability, cost and the ease of which the wrapping material can be wrapped round the louver. Other considerations such as colour may be important. The wrapping may be made from a plastics material such as a polymer. For example, the polymers can include polyvinylchloride, polyethylene and polypropylene. Other suitable materials can include wood veneer, paper or fabric. Although at least a part of the wrapping will be retained in the slot, optionally with the retaining member, the wrapping may also be provided with an adhesive backing.

According to the second aspect of the present invention, there is provided a window, door, shutter or blind comprising at least one louver as previously described. The louver or louvers may be fixed or may be pivotable between an open or closed configuration. If more than one louver is provided, then the louvers may be independently moveable, or may be part of a known mechanism whereby some of all louvers are moved together synchronously.

According to a third aspect of the present invention, there is provided a method of making a louver for a shutter, blind or window comprising the following steps: a) providing an elongate body having opposed ends, the body having an outer surface; and a slot extending between the opposed ends; and b) disposing a wrapping about the outer surface of the louver, and inserting at least part of the wrapping into the slot to retain it.

The method may comprise further step c) inserting at least one retaining member into the slot to retain the wrapping between the retaining member and an inner surface of the slot.

The slot can be provided by any known means. For example, the louver may be manufactured from a solid work piece, and the slot is subsequently machined, or alternatively the louver can be moulded or extruded with the slot already in place.

Any manufacturing process known in the art for applying the wrapping to the louver may be used in respect of this aspect of the present invention. The process may be automatic, or manual. Automatic processes that may be used in respect of the present invention include profile wrapping. This process uses a profile wrapping machine where a plurality of rollers are positioned to form the wrapping onto the louver. During the process an adhesive is applied to the back surface of the wrapping material so as to adhere the wrapping material to the louver. Alternatively, the wrapping material may be applied manually using hand tools such as a scraper spreader, wherein the wrapping material is provided with an adhesive backing or an adhesive can be applied separately.

As previously described, the wrapping may be generally rectangular and comprise first opposed edges which are aligned with the opposed ends of the louver, and second opposed edges wherein the second opposed edges are inserted into the slot.

### BRIEF DESCRIPTION OF THE DRAWINGS

Certain embodiments of the present invention will now be described in detail, but by way of example only, with reference to the following figures wherein:

FIG. 1a shows an end view of a first embodiment of a louver according to the present invention;

FIG. 1b shows a plan view of a first embodiment of a louver according to the present invention;

FIG. 1c shows a side view of a first embodiment of a louver according to the present invention;

FIG. 2 shows an end view of a second embodiment of a louver according to the present invention;

FIG. 3a shows an end view of a third embodiment of a louver according to the present invention;

FIG. 3b shows a plan view of a third embodiment of a louver according to the present invention;

FIG. 3c shows a side view of a third embodiment of a louver according to the present invention; and

FIG. 4 shows a schematic perspective view of a shutter comprising a louver according to the present invention.

### DETAILED DESCRIPTION

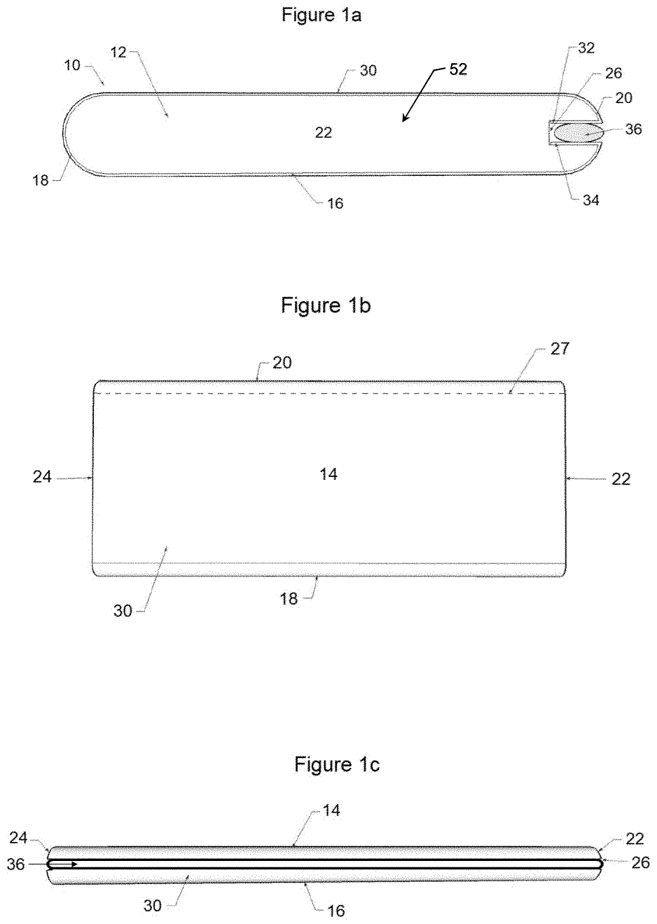

Turning first to FIGS. 1a to 1c, there is shown an end view of a first embodiment of louver, generally indicated 10, for use in a window, door, shutter, blind or similar. The louver 10 comprises an elongate body 12, the body 12 comprising parallel upper face 14 and a lower face 16, and opposed rounded side faces 18 and 20. The body 12 also comprises two end faces 22 and 24. A slot 26 is provided in side face 20 (shown with broken line 27 on FIG. 1b), said slot 26 extending the length of body 12 between the end faces 22 and 24.

The slot may take any shape into which the wrapping can be inserted. Slot 22 has a generally rectangular profile, though alternatively this may be U-shaped, or horseshoe-shaped profile. The profile of slot 22 extends into the body from an opening, the height of the slot from the opening remains constant. In alternative embodiments, the profile may narrow as it extends into the body, for example a U shape or V shaped profile. Further still, the profile may include a portion having a height greater than that of the opening, for example a C shape or horseshoe-shaped profile. As shown most clearly in FIG. 1a, the side face 18 and 20 are rounded, and so face 20 tapers in towards the opening of the slot 26.

A wrapping, generally indicated 30, is provided about the body 12. The wrapping 30 extends the full length of the body 12, and is aligned with the end faces 22, 24. The wrapping 30 encircles the body 12 entirely, so as to completely cover it. Free ends of the wrapping, indicated 32 and 34 are tucked into, and retained in, the slot 26.

Retaining member, generally indicated 36, is disposed in slot 26, and is dimensioned so as to clamp or grip the free ends 32 and 34 of the wrapping 30 against the inside surface of the slot 22, thus retaining the wrapping 30 in place. Each free end 32 and 34 is clamped against a different inside surface of the slot 26 by contact with the retaining member 36. The retaining member extends the full length of the body 12 between the end faces 22 and 24. In this case the slot 26 has a substantially rectangular profile and the retainer 36 is substantially oval.

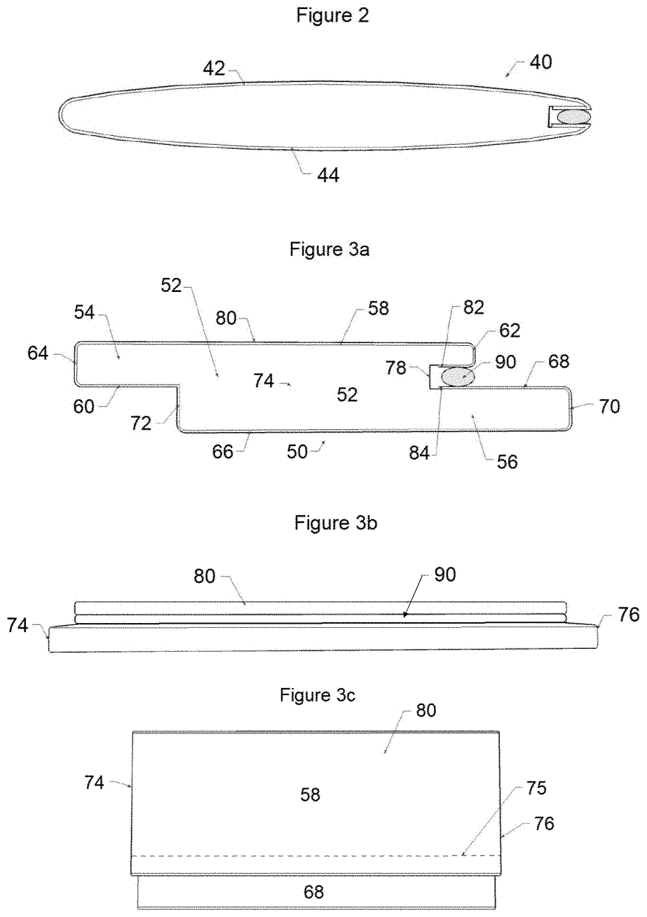

FIG. 2 shows an alternative embodiment of louver to that shown in FIGS. 1a-c. The louver, generally indicated 40, differs from the louver described in relation to FIGS. 1a-c only in that the opposed top and bottom faces, indicated 42 and 44 are outwardly-curving, rather than parallel.

FIGS. 3a, 3b and 3c shows an alternative embodiment of louver, generally indicated 50. The louver 50 comprises a body 52 which has a cross section that comprises upper and lower offset rectangles, referred to by the numerals 54 and 56 respectively. Upper rectangle 54 comprises a longer upper face 58, shorter lower face 60 and opposed side faces 62 and 64. Lower rectangle 56 comprises a longer lower face 66, shorter upper face 68 and opposed side faces 70 and 72.

Body 52 further comprises two end faces 74 and 76.

A slot 78 is provided in side face 62 of the upper rectangle 54, flush with the shorter upper face 68 of the lower rectangle 56. Said slot 74 extends the length of body 52 between the end faces 74 and 76, as shown by broken line 75 in FIG. 3c A wrapping, generally indicated 80, is provided about the body 52. The wrapping 80 extends the full length of the body 52, and is aligned with the end faces 74, 76. The wrapping 80 encircles the body 52 entirely, so as to completely cover it. Free ends of the wrapping, indicated 82 and 84, are tucked into the slot 26.

Retaining member, generally indicated 90, is disposed in slot 78, and is dimensioned so as to clamp the free ends 82 and 84 of the wrapping 80 against the inside surface of the slot 78, thus retaining the wrapping 80 in place. The retaining member extends the full length of the body 52 between the end faces 74 and 76.

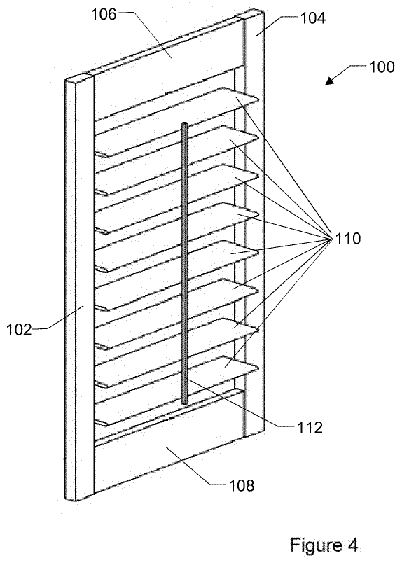

A demonstration of louvers according to the present invention in use is shown in FIG. 4, which shows a schematic perspective view of a shutter, generally indicated 100. Shutter 100 comprises opposed stiles 102, 104 and opposed rails 106, 108. A plurality of louvers 110 are hingedly mounted to the opposed stiles 102, 104. An actuating bar 112 is hingedly mounted to an outer edge of each louver 110. The louvers 100 are all disposed at an angle parallel to one another, and the respective angle of the louvers 110 can be adjusted by manually raising or lowering the actuating bar 112.

In use the shutter 100 may be installed in the window of a property so that the actuating bar 112 is internal to the property, and the slots (not shown) on the louvers 110 are external, so as not to be visible from within the property.

1. A louver, the louver comprising:
an elongate body having opposed ends, the body having an outer surface;
a slot extending between the opposed ends; and
a wrapping disposed about the outer surface of the louver, wherein at least part of the wrapping is retained in the slot.

2. The louver of claim 1 further comprising at least one retaining member disposed within the slot to retain the wrapping between the retaining member and an inner surface of the slot.

3. The louver of claim 1, wherein the wrapping is generally rectangular and comprises first opposed edges aligned with the opposed ends of the louver, and second opposed edges.

4. The louver of claim 3, wherein the second opposed edges are retained within the slot.

5. The louver of claim 1, wherein the elongate body has a cross section that is symmetrical about a horizontal and vertical axis and comprises opposed top and bottom faces and opposed side faces.

6. The louver of claim 1, wherein the elongate body has a cross section comprising two offset rectangles, wherein the elongate body comprises opposed top and bottom faces and opposed side faces.

7. The louver of claim 1, wherein the slot is disposed on one of the side faces.

8. The louver of claim 1, wherein the slot has a generally U-shaped or horseshoe-shaped profile.

9. The louver of claim 2, wherein the retaining member extends the length of the slot.

10. The louver of claim 1, wherein the louver is made from wood, plastic, glass or metal.

11. The louver of claim 1, wherein the wrapping is made from one of polyvinylchloride, polyethylene, polypropylene, paper or fabric.

12. The louver of claim 1, wherein the retaining member is made from wood, plastic, glass or metal.

13. A shutter, blind or window comprising at least one louver as claimed in claim 1.

14. The shutter, blind or window of 13, wherein the louvers are fixed or pivotable between an open or closed configuration.

15. A method of making a louver for a shutter, blind or window comprising the following steps:
a) providing an elongate body having opposed ends, the body having an outer surface; and a slot extending between the opposed ends; and
b) disposing a wrapping about the outer surface of the louver, and inserting at least part of the wrapping into the slot to retain it.

16. The method of claim 15, further comprising: step c) inserting at least one retaining member into the slot to retain the wrapping between the retaining member and an inner surface of the slot.

17. The method of claim 16, wherein the wrapping is generally rectangular and comprises first opposed edges which are aligned with the opposed ends of the louver, and second opposed edges wherein the second opposed edges are inserted into the slot.
